(19) United States
(12) Patent Application Publication
(10) Pub. No.: US 2023/0341294 A1
(43) Pub. Date: Oct. 26, 2023

(54) METHOD FOR ANALYZING AN EMITTED AMOUNT OF SUBSTANCE

(71) Applicant: DEERE & COMPANY, MOLINE, IL (US)

(72) Inventor: CHRISTOPHE GOSSARD, WEINHEIM (DE)

(21) Appl. No.: 17/760,008

(22) PCT Filed: Jan. 20, 2021
(86) PCT No.: PCT/EP2021/051180

§ 371 Date: Aug. 3, 2022

(30) Foreign Application Priority Data
Feb. 3, 2020 (DE) 102020201283.0

(51) Int. Cl. G01M 15/10; F02D 41/14; G07C 5/08; H04L 9/00; H04W 4/40; H04L 9/40

(52) U.S. Cl. CPC G01M 15/102; F02D 41/1462; G07C 5/08; H04L 9/50; H04W 4/40; H04L 63/0428; H04L 2209/84

(57) ABSTRACT

A method for analyzing an amount of substance emitted as a result of the operation of a functional unit of a utility vehicle includes generating signals from a signal source independently of the amount of substance, transmitting the signals to a data processing apparatus as input data for determining the emitted amount of substance, processing the input data in the data processing apparatus to form output data which represent the emitted amount of substance, and transferring the output data as transfer data to a storage unit of a digital distributed ledger.

### CROSS-REFERENCE TO RELATED APPLICATIONS

This application claims priority to German Patent Application DE102020201283.0, titled METHOD FOR ANALYZING AN EMITTED AMOUNT OF SUBSTANCE, filed Feb. 3, 2020 and PCT application PCT/EP2021/051180, titled METHOD FOR ANALYZING AN EMITTED AMOUNT OF SUBSTANCE, filed Jan. 20, 2021, which are hereby incorporated by reference in their entireties.

### BACKGROUND

The disclosure relates to a method for analyzing an amount of substance emitted as a result of the operation of a functional unit of a utility vehicle.

One criterion in utility vehicles is emissions of specific substances during the operation of their internal combustion engine. In this case, the ability to reliably measure and/or analyze amounts or concentrations of these emitted substances is of interest.

### SUMMARY

According to an aspect of the present disclosure, a method for analyzing an amount of substance emitted as a result of the operation of a functional unit of a utility vehicle includes generating signals from a signal source independently of the amount of substance, transmitting the signals to a data processing apparatus as input data for determining the emitted amount of substance, processing the input data in the data processing apparatus to form output data which represent the emitted amount of substance, and transferring the output data as transfer data to a storage unit of a digital distributed ledger.

The method may further include transmitting the signals generated independently of the amount of substance as input data to a data processing apparatus which contains at least one neural network as a trained model for processing the input data and generating the output data in the data processing apparatus using the at least one neural network. The method may further include transferring the signals generated independently of the amount of substance as transfer data to at least one of the storage unit and a second storage unit of the digital distributed ledger. The method may further include generating process data, assigning the process data to the signals generated independently of the amount of substance or to the output data, and transferring the process data as transfer data to the storage unit of the digital distributed ledger. The method may further include storing the transfer data in an unalterable manner. The method may further include storing the transfer data in encrypted form. The method may further include encrypting the transfer data in a processing stage connected downstream of the data processing apparatus before transferring the transfer data to the digital distributed ledger. The method may further include encrypting the transfer data in a control unit of the utility vehicle before transferring the transfer data to the digital distributed ledger. The method may further include transferring the encrypted transfer data to the digital distributed ledger with a data interface of the utility vehicle. The method may further include accessing data content or a copy of the data content of the storage unit of the digital distributed ledger on the basis of an access authorization. The method may further include effecting access to the data content or the copy of the data content of the storage unit of the digital distributed ledger using a data network. The method may further include utilizing blockchain technology to carry out at least one of the steps of processing the input data and transferring the output data. The substance of the emitted amount of substance may include at least one of NOx, CO2, CO, CmHn, N, NH4, P, and K. The functional unit may include at least one of an internal combustion engine, an exhaust gas aftertreatment system, and a filling or application device for liquid manure. The signals generated independently of the amount of substance may represent at least one of an exhaust gas temperature, a torque of an internal combustion engine, a speed of an internal combustion engine, and a variable influencing a liquid manure composition. The method may further include transmitting the input data to the data processing apparatus and transferring the transfer data to the storage unit of the digital distributed ledger on the basis of a comparison between the signals from the signal source and at least one predefined reference value. The predefined reference value as a calibration value may represent a calibration state of the functional unit, and the signal from the signal source may represent an actual state of the functional unit. The method may further include transmitting the input data to the data processing apparatus if a value of the signal from the signal source is greater than the predefined reference value. The method may further include transferring the transfer data to the storage unit of the digital distributed ledger if a value of the signal from the signal source is greater than the predefined reference value. The method may further include checking that the emitted amount of substance complies with a predetermined limit value.

Other features and aspects will become apparent by consideration of the detailed description, claims, and accompanying drawings.

### BRIEF DESCRIPTION OF THE DRAWINGS

The detailed description of the drawings refers to the accompanying figures.

FIG. 1 shows an arrangement for carrying out the method in accordance with an embodiment of the disclosure;

FIG. 2 shows an arrangement for carrying out the method in accordance with an embodiment of the disclosure;

FIG. 3 shows an arrangement for carrying out the method in accordance with an embodiment of the disclosure; and

FIG. 4 shows the arrangement according to FIG. 1 in combination with a schematically illustrated data architecture for carrying out the method in accordance with an embodiment of the disclosure.

Like reference numerals are used to indicate like elements throughout the several figures.

### DETAILED DESCRIPTION

The present disclosure is based on the object of being able to analyze an amount of substance emitted as a result of the operation of a functional unit of a utility vehicle with little technical effort. A method of one embodiment may be used to determine an amount of substance emitted as a result of the operation of a functional unit of a utility vehicle. In this case, signals from a signal source which are generated independently of the substance to be examined or the amount of substance to be determined are transmitted to a data processing apparatus as input data. The data processing apparatus is used to determine the emitted amount of substance, in particular by means of suitable algorithms, for example artificial intelligence.

The signal source is used to provide signals which are generated independently of the amount of substance. These signals therefore do not represent an amount of substance, but form input data for the data processing apparatus. The latter in turn processes the input data to form output data representing the emitted amount of substance. Combining, for example, signals which are available in the utility vehicle anyway (for example sensor system, control unit) with the data processing apparatus therefore makes it possible to determine the amount of the respectively emitted substance in a technically simple and cost-effective manner.

The output data from the data processing apparatus are transferred—possibly in a further processed form—as transfer data to a storage unit of a digital distributed ledger. The ledger makes it possible to document all data transactions. There is therefore the prerequisite that the emitted amount of substance is reliably documented, on the one hand, and can be clearly analyzed if necessary, on the other hand. As a result, the functional unit can be reliably checked at any time in order to determine whether it is operating within a (for example technically and/or legislatively) defined framework.

The storage unit may be in the form of a defined storage location and/or in the form of a type of database inside the ledger.

The distribution property of the ledger makes it possible for third parties to be able to reliably analyze the emitted amount of substance of the functional unit at any time (for example in real time or subsequently). The ledger can therefore be used as a type of data network.

The distribution property of the ledger may include a person-related restriction of the participants in the ledger (permissioned distributed ledger). In such an embodiment, only authorized third parties (for example with a corresponding access authorization) can therefore perform data transactions and/or analyze the emitted amount of substance of the functional unit. These third parties are, for example, the user or manufacturer of the functional unit, cooperation partners or subcontractors of the manufacturer or legislatively provided institutions (for example technical testing authority). The ledger is then used as a type of private data network with a restricted group of participants.

The participants of the ledger or their technical units or modules communicating with the ledger may have an appropriate digital certificate in order to be identified as authorized ledger participants.

Overall, an emitted amount of substance of the functional unit can be determined and analyzed with little technical effort using the measures described above.

At least one sensor, a combination of a plurality of sensors or a control unit may be provided for the purpose of generating and providing the signals which are independent of the amount of substance. These signal sources have the advantage that, in many cases, they are already routinely available in the utility vehicle without additional outlay. In this case, the control unit may also receive signals from a control and/or data bus (for example CAN, ISO) and can provide them as signals which are independent of the amount of substance. Sensor signals derived from a family of characteristics may also be provided using the control unit. In other cases, the sensor or the sensor system may be part of a unit outside the utility vehicle, for example a satellite, drone, weather station. The signals or data therefrom can then be initially supplied to a control unit or can be transmitted directly to the data processing apparatus as input data. Data from a data network (for example Internet) can also be used as input data. The latter data may possibly be initially supplied to a control unit which then transmits the relevant data to the data processing unit as input data.

Different emitted substances which are each examined or tested with regard to their emitted amount (for example concentration, number of particles, particle flow, volumetric flow) are conceivable as the determined amount of substance. The specific amount of substance can be examined or determined independently of its state of matter (solid, liquid, gaseous). Individual substances having a plurality of states of matter at the same time can also be analyzed in terms of their amount by an appropriately designed data processing apparatus.

The data processing apparatus may be designed to examine an individual substance and consequently to determine a single specific amount of substance. Alternatively, the data processing apparatus is designed in such a manner that it is suitable for examining a plurality of different specific substances.

The utility vehicle of an embodiment is, in particular, an agricultural utility vehicle, for example a tractor. Further examples are forestry utility vehicles and construction machines. The utility vehicle of additional embodiments may include any one or more on- or off-road vehicles.

The data processing apparatus may contain at least one neural network as a trained model for processing the input data. Output data representing the emitted amount of substance are generated in the data processing apparatus using the at least one neural network. The use of the data processing apparatus with the at least one neural network makes it possible for input data to be able to be processed reliably with a high degree of accuracy, on the one hand, and with little technical effort, on the other hand. Such artificial intelligence requires only a specific definition phase and a specific learning phase (training phase) until it provides sufficiently accurate output data for correctly determining the amount of substance. After this definition and learning phase has been completed, this artificial intelligence, as a software-based, in particular algorithm-based, model, is suitable for being used as a technical model and therefore as a replacement for a technically complicated and accordingly cost-intensive sensor system in the utility vehicle.

It is therefore possible to avoid, for example, a costly sensor system for determining an emitted nitrogen oxide concentration (NOx). Rather, the amount of the respectively emitted substance can be determined in a technically simple and cost-effective manner by combining signals which are available in the utility vehicle anyway (for example sensor system, control unit, CAN bus, ISO bus) with the at least one neural network. In this case, the respective neural network or model may be trained in the definition and learning phase with the aid of exactly the same signals which are available in the utility vehicle anyway. During operation of the functional unit, the data processing apparatus or its at least one neural network can then be used as a trained, virtual sensor system in order to determine the relevant amount of substance in a technically reliable and cost-effective manner.

In one embodiment, further transfer data, specifically the already mentioned signals generated independently of the amount of substance, are transferred to the ledger. These signals or data may be transferred—possibly in a further processed form—to a storage unit of the ledger that is separate from the storage unit of the output data. Storing these data in the distributed ledger makes it possible to access these data if necessary and with appropriate authorization. For example, the plausibility of the emitted amount of substance can be verified with little technical effort on the basis of these stored signals or input data.

On the basis of the generated signals from the signal source and/or output data—generally basic data—it is also possible to generate process data which are assigned to individual basic data and are likewise transferred as transfer data to a storage unit of the ledger. These process data may contain, for example, a proof of origin of the basic data and/or a time stamp of the basic data. The process data may be transferred, together with the respective basic data, to the corresponding storage unit of the ledger. As a result, the process data can support the authenticity of the basic data. The authenticity of the basic data can be checked in an even simpler manner in terms of data technology.

Transfer data may be stored in a corresponding storage unit of the ledger in an unalterable manner. The transfer data may include the above-mentioned basic data and/or process data. This supports tamperproof provision of the data content of the respective storage unit.

The tamper protection of the transfer data to be stored in the ledger is also supported by, for example, storing these data in an encrypted form. Strong encryption may be carried out, for example, in the form of hash-protected data blocks.

The output data representing the emitted amount of substance may be encrypted in a processing stage connected downstream of the data processing apparatus before they are transferred to the ledger as encrypted data. The processing stage may be arranged in the utility vehicle or may be in the sphere of influence of the manufacturer of the functional unit or of the utility vehicle. For the encryption, the processing stage has a suitable digital key. The processing stage also may have a digital certificate which authorizes it to participate in the ledger or the data network.

The signals generated independently of the amount of substance can be encrypted in a control unit in the utility vehicle. For the encryption, the control unit has a suitable digital key. This control unit may also have a digital certificate which authorizes it to participate in the ledger or the data network.

The encrypted data may be transferred to the ledger using one (or more) suitable data interfaces (gateway). Depending on the respective data category (for example signals generated independently of the emitted amount of substance, output data, process data), it is technically advantageous to use an interface arranged in the utility vehicle. This makes it possible to use interfaces which are present as standard and enable a data connection (for example telecommunications infrastructure, mobile radio) between the control unit and the ledger. The technical effort needed to provide a suitable interface can accordingly be kept low.

The handling of the distributed ledger may be controlled in such a manner that, on the basis of an authorization for access or read access, the data content of individual or all storage unit(s) or a copy of this data content can be accessed. As a result, an authorized third party, for example the manufacturer or user of the functional unit or an institution (for example, a technical inspection agency and/or a testing authority), can check the method of operation of the functional unit with little technical effort, whether in a random manner or over a defined operating period of the functional unit, for example. The access authorization restricts the group of persons to officially authorized persons who can connect to the ledger acting as a private network.

The respective data content or a copy of this data content can be accessed by authorized persons by means of a data network (for example Internet).

A blockchain technology may be used to carry out the method. This makes it possible to implement desired properties such as authenticity or tamper protection of the stored data in a particularly reliable manner. In particular, it is a private data network (private blockchain) with a group of participants authorized and restricted in a defined manner by suitable access rules. Individual participants may also have different data transfer and/or data access authorizations in terms of the volume of data. The technology under the term “blockchain” is generally known (for example Blockchain for Dummies, Manav Gupta, 2017, ISBN: 978-1-119-37123-6).

Substances that may be examined with regard to their emitted amount of substance are various nitrogen oxides NOx such as NO and NO2, carbon dioxide (CO2), carbon monoxide (CO), hydrocarbons (CmHn). These substances are relevant, for example, when operating an internal combustion engine as a functional unit.

Further substances to be determined may be ammonium (NH4) and the chemical elements N, P, K, wherein these elements may be determined in elemental form or in bound form, for example nitrogen compounds, nitrate (NO3), phosphate (P2O5), potassium (K2O). These substances are relevant, for example, when applying organic fertilizer or liquid manure, such as during operation of a filling or application device of a liquid manure trailer.

The nitrate concentration in the soil (for example of a field or a meadow) can also be determined as an emitted amount of substance. In this case, the amount of nitrate or nitrate concentration is emitted indirectly by application of liquid manure or nitrogen to the soil and subsequent conversion in the soil.

The method can be applied to different functional units which emit an amount of substance to be examined or determined. In particular, an internal combustion engine or an exhaust gas aftertreatment system of the utility vehicle is conceivable as a functional unit. Furthermore, attachments or subunits of the latter are also conceivable as a functional unit of the utility vehicle since they perform a function during the deployment of the utility vehicle. For example, this is a filling or application device (for example nozzle, valve, line) for liquid manure, such as on a liquid manure trailer. In all cases, a technically complicated and accordingly cost-intensive sensor system and measuring apparatus can be avoided when using the method according to the disclosure.

Signals from the respective signal source may represent one or more parameters of the functional unit. In particular, the signals are used to represent a current state or actual state of the functional unit with respect to a parameter. The data processing apparatus can therefore continuously take into account a current state of the functional unit.

On the one hand, the signals of the parameters are independent of direct determination of an amount of substance and are simultaneously related to the current state and current properties of the functional unit. On the other hand, these parameters are routinely available in many cases in the utility vehicle, in particular as a result of a conventional sensor system. The technical effort needed to provide signals which are independent of the amount of substance for the purpose of determining the amount of substance therefore remains low.

Suitable signals as input data for the data processing apparatus are, for example, parameter values of at least one of the following parameters: an exhaust gas temperature of the combustion gases of an internal combustion engine of the utility vehicle, a torque of the internal combustion engine, a speed of the internal combustion engine. Further parameters may be environmental conditions (for example temperature, external air pressure) of the functional unit or other technical parameters of the functional unit.

The above-mentioned parameters are suitable, in particular, in the case of an internal combustion engine or an exhaust gas aftertreatment system as a functional unit.

In the case of a filling or application device for liquid manure (for example arranged on a liquid manure trailer) as a functional unit, variables influencing the liquid manure composition (for example the type of animal, the feed of the animals, type and/or duration of the storage of the liquid manure) can be used as parameters.

In the case of a nitrate concentration of the soil as an amount of substance to be determined, apart from the above-mentioned parameters in connection with the filling or application device for liquid manure as a functional unit, the following parameters come into consideration, for example: different weather conditions, solar radiation, surface condition of the field in question.

Input data may be transmitted to the data processing apparatus on the basis of a comparison between signals from a signal source and at least one predefined reference value. This makes it possible for input data to be transmitted, in an embodiment, only on the basis of a particular comparison result. A suitable comparison can therefore control the fact that an examined amount of substance is not determined continuously, but rather only under specifically determined conditions in an embodiment, specifically only when the determination appears to be necessary. This advantageously reduces the number of data transactions and the computing capacity required. Depending on the data transmission means used, this reduction also saves costs.

In one embodiment, the predefined reference value is effective as a calibration value representing a calibration state of the functional unit. This calibration state can then be compared with a current actual state of the functional unit that is represented by means of signals from the signal source. For example, the calibration state of an internal combustion engine is predefined by reference values, in particular maximum values which should not be exceeded, which were obtained in a test phase or during homologation of the internal combustion engine. These reference values relate, for example, to a maximum torque of the internal combustion engine, a maximum speed of the internal combustion engine or a maximum exhaust gas temperature of the combustion gases of the engine. A comparison between the calibration state and the actual state is therefore suitable as a preliminary check for efficiently deciding whether an emitted amount of substance actually needs to be determined.

In particular, input data are transmitted to the data processing apparatus, in an embodiment, only when the value of the signal from the signal source (for example a measured torque of the internal combustion engine) is greater than the predefined reference value (for example a maximum torque determined during homologation of the internal combustion engine). For the purposes of data economy, an emitted amount of substance would therefore be determined, in an embodiment, only when there is an indication of a potentially excessively high amount of substance.

The method may be used to analyze the emitted amount of substance in order to determine whether it complies with a predetermined limit value. This may be, for example, a maximum value which is stipulated by the manufacturer of the functional unit or is legislatively stipulated and should be complied with or must not be exceeded. For this purpose, the output data from the data processing apparatus may be supplied, for example, to a corresponding comparison algorithm in the downstream processing stage which has already been mentioned. If the processing stage is assigned to the sphere of influence of the manufacturer of the functional unit, the manufacturer can check the compliance with the limit value in a technically simple manner. However, authorized persons, even without the processing stage, can check whether the emitted amount of substance complies with a predetermined limit value by accessing the ledger or the data/data transactions stored there.

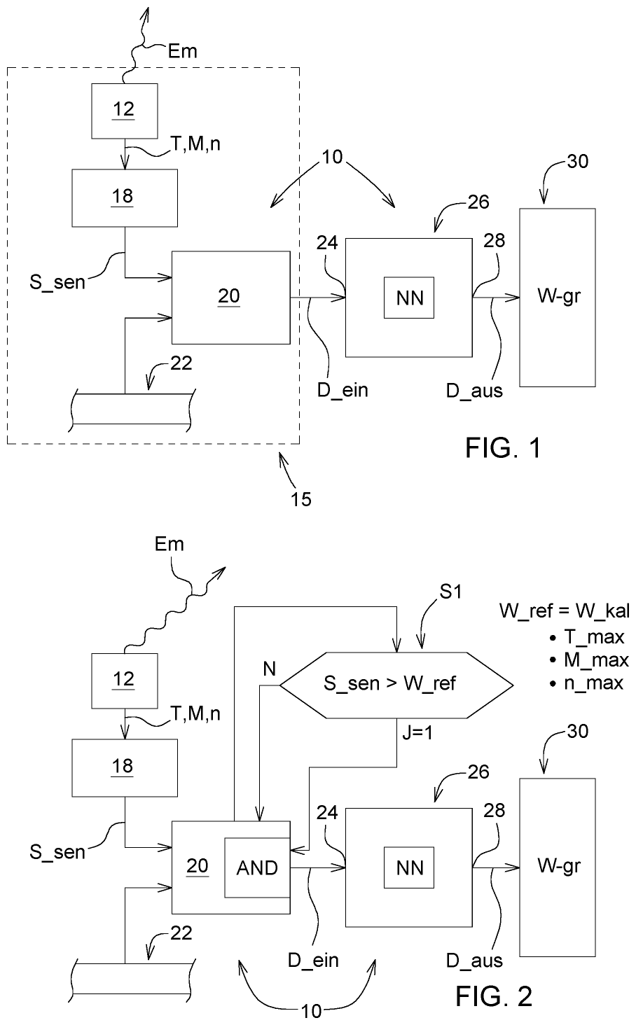

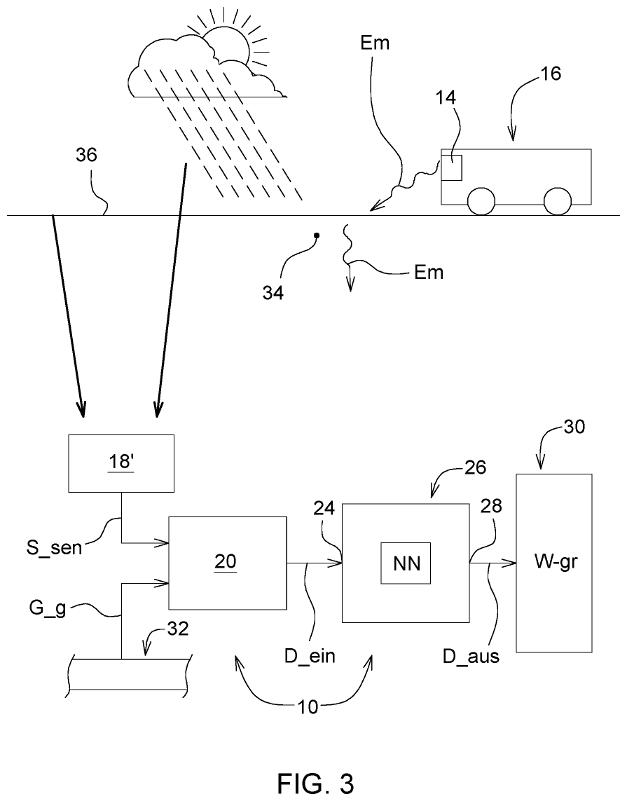

FIG. 1 shows an arrangement 10 having a plurality of parts for determining an amount of substance Em emitted as a result of the operation of a functional unit 12, 14 of a utility vehicle 15, in particular a tractor. In FIG. 1 and FIG. 2, the functional unit 12 is an internal combustion engine of the utility vehicle, whereas, in the embodiment according to FIG. 3, the functional unit 14 is in the form of an application device for liquid manure, which is illustrated only schematically. This application device 14 is part of a liquid manure trailer 16 which is pulled by the utility vehicle 15 during operation. The arrangement 10 may be partially or completely in the form of part of the utility vehicle 15.

According to FIG. 1, a sensor system 18 records current values of parameters of the internal combustion engine 12, for example an exhaust gas temperature T, a torque M and an engine speed of the internal combustion engine 12. For the sake of simplicity, the sensor system 18 is mentioned here as the umbrella term for the individual sensors needed to record the parameters. The sensor signals S_sen generated by means of the sensor system 18 independently of the amount of substance Em to be determined are supplied to a control unit 20. The control unit 20 may contain the functionalities needed for signal or data processing, for instance a reading and/or writing unit, a storage unit, a processor. In addition, signals or data from a data and/or control bus 22 are also supplied to the control unit 20. This bus 22 may be located in or with the vehicle, for example a CAN bus.

The control unit 20 transmits received signals or data from the sensor system 18 and the bus 22, possibly in a processed form, as input data D_ein to an input 24 of a data processing apparatus 26.

Alternatively, the sensor signals S_sen may also be transmitted to the data processing apparatus 26 directly, without the interposition of the control unit 20.

The data processing apparatus 26 contains at least one neural network NN which is in the form of a trained, software-based model for processing the input data D_ein. The at least one neural network NN forms, as it were, a virtual sensor system which replaces a direct measurement of the emitted amount of substance Em.

In the data processing apparatus 26, output data D_aus, which are present at an output 28 of the data processing apparatus 26 and represent the emitted amount of substance Em, are generated using the at least one neural network NN.

The output data D_aus are supplied to a processing stage 30 in which the output data D_aus, possibly in a further processed data form, are compared with a predetermined limit value W_gr. The comparison is used to check whether the predetermined limit value W_gr is complied with, in particular is not exceeded, by the value of the output data D_aus and consequently by the value of the computationally determined amount of substance Em. Information for users of the functional unit 12 or for third parties, which is dependent on the comparison result, can also be generated and output in the processing stage 30. Furthermore, measures may be initiated in the processing stage 30, for example by outputting appropriate control signals.

The data processing apparatus 26 may be arranged outside the utility vehicle 15 and in the sphere of influence of the manufacturer producing the functional unit 12 and/or the utility vehicle 15.

The processing stage 30 may be likewise arranged outside the utility vehicle 15 and in the sphere of influence of the manufacturer producing the functional unit 12 and/or the utility vehicle 15.

The arrangement according to FIG. 2 differs from the embodiment according to FIG. 1 substantially in that signals S_sen from the sensor unit 18 are compared with a predefined reference value W_ref in the control unit 20 during a comparison step S1. Input data D_ein are transmitted to the data processing apparatus 26 on the basis of the comparison result in the comparison step S1.

In the exemplary embodiment, the reference value W_ref corresponds to a calibration value W_kal representing a calibration state of the internal combustion engine 12. The calibration state has been defined by means of a test phase or homologation of the internal combustion engine 12. In other words, a reliable operating range for the internal combustion engine 12 has been defined thereby. The calibration value W_kal therefore corresponds, for example, to a maximum permissible exhaust gas temperature T_max, a maximum permissible torque M_max or a maximum permissible speed n_max of the internal combustion engine 12.

Signals S_sen from the sensor system 18 represent a captured actual state of the internal combustion engine 12 since the sensor system 18 records current values of individual parameters of the internal combustion engine 12, for example the current exhaust gas temperature T, the current torque M and/or the current engine speed n.

The calibration state of the internal combustion engine 12 is therefore compared with its actual state with respect to selected parameters in the comparison step S1. If the comparison reveals that the current value of the selected parameter does not exceed the predefined reference value W_ref or the calibration value W_kal (this means S_sen≤W_ref), the control unit 20 decides not to transmit any input data D_ein to the data processing apparatus 26. In contrast, if the comparison reveals that the current value of the considered parameter exceeds the predefined reference value W_ref or the calibration value W_kal (this means S_sen>W_ref), the control unit 20 causes input data D_ein to be transmitted to the data processing apparatus 26. For this purpose, the binary value J=1 can be assigned to the YES output of the comparison step S1, which binary value, as a result of its processing in an AND operator AND, causes the control unit 20 to transmit the input data D_ein.

Input data D_ein are therefore, in an embodiment, transmitted to the data processing apparatus 26 by means of the comparison step S1 only when operation of the internal combustion engine 12 outside its calibration state has been determined. In the embodiment, only then could an excessively high emitted amount of substance Em arise, which is therefore calculated using the data processing apparatus 26. The comparison step S1 therefore avoids unnecessary data transactions if the internal combustion engine 12 operates within its predefined calibration state.

In the embodiments according to FIG. 1 and FIG. 2, the arrangement 10 determines an emitted amount of substance Em of at least one of the substances NO, NO2, CO2, CO, CmHn. These substances are of interest in connection with operation of the internal combustion engine 12.

In contrast, the arrangement 10 according to FIG. 3 determines an emitted amount of substance Em in connection with the application of liquid manure to an agricultural area. For example, the amount of substance Em of at least one of the following substances is determined here: ammonium (NH4), phosphate (P2O5), potassium (K2O), nitrogen (N), nitrate (NO3).

In the embodiment according to FIG. 3 as well, signals are generated independently of the amount of substance Em to be determined and are provided in the control unit 20, possibly in a processed form, in order to then be transmitted to the data processing apparatus 26 as input data D_ein. In accordance with the intended use in FIG. 3, the neural network NN is specifically trained, as a virtual sensor system, to calculate or determine the emitted amount of a substance emitted by applied liquid manure (for example NH4, P2O5, K2O, N, NO3).

The signals provided by the control unit 20 are based on sensor signals S_sen and/or on signals or data from a data network 32 (for example Internet). The latter may be used, for example, such that a farmer or user transmits a variable G_g influencing the liquid manure composition to the control unit 20 as a parameter. This variable G_g may also be automatically transmitted as data from a database or as sensor signals to the control unit 20 via the data network 32.

The variable G_g influencing the liquid manure composition may be a type of animal producing the liquid manure, the feed of the animals or the type and/or duration of the storage of the liquid manure.

In the case of a nitrate concentration in the soil 34 as the amount of substance Em to be determined, apart from the above-mentioned variable(s) G_g, the following parameters come into consideration, for example, as parameters: weather conditions, solar radiation, surface condition of the field 36 in question. The values of these parameters may be recorded by means of a suitable sensor system 18′. This sensor system 18′ contains at least one sensor and may be at least partially part of one or more unit(s) outside the utility vehicle 15 being operated, for example a satellite, drone, weather station. The signals or data S_sen therefrom are then supplied to the control unit 20.

The nitrate concentration in the soil 34 may likewise be determined as an emitted amount of substance Em. In this case, the amount or concentration of nitrate is emitted indirectly by application of liquid manure or nitrogen to the soil 34 and subsequent conversion in the soil 34.

In FIG. 3, the output data D_aus representing the respectively emitted amount of substance Em from the data processing apparatus 26 are again supplied to a processing stage 30. With respect to the function of the processing stage 30 in FIG. 3, reference is made to the explanations of the embodiment according to FIG. 1.

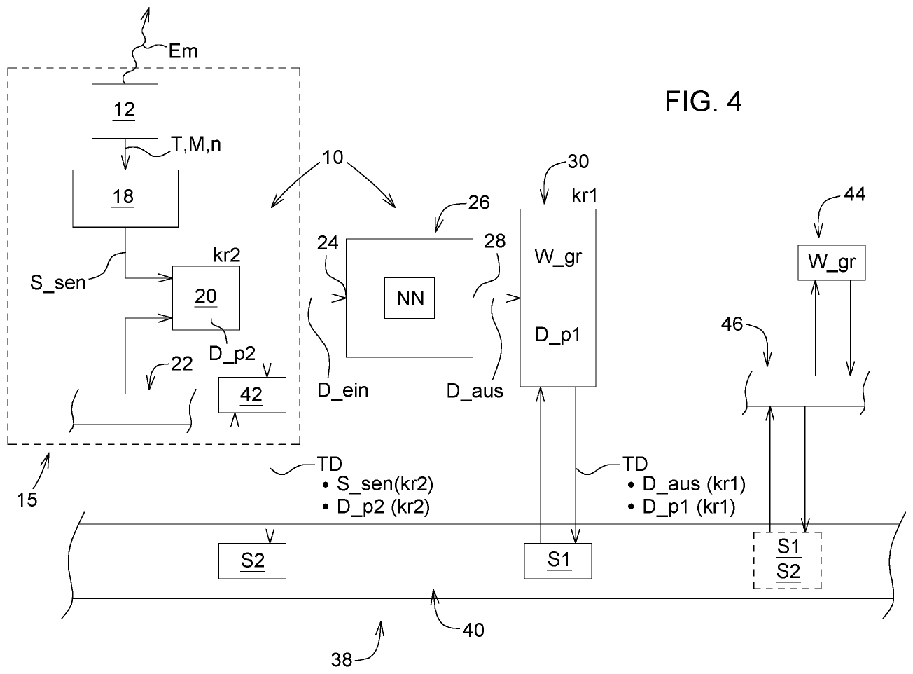

In FIG. 4, the arrangement 10 is combined with a data architecture 38. In this case, the arrangement 10 corresponds to the embodiment according to FIG. 1. However, it goes without saying that other embodiments of the arrangement 10 can also be combined with the data architecture 38.

By means of the data architecture 38, the emitted amount of substance Em is recorded or documented and analyzed as required by authorized persons. For this purpose, the output data D_aus are transferred as transfer data TD to a storage unit S1 of a digital distributed ledger 40. The signals S_sen are likewise transferred as transfer data TD to a storage unit S2 of the ledger 40.

In parallel with the output data D_aus and signals S_sen, which can together be referred to as basic data, process data D_p1 and D_p2 are generated. These process data may comprise specific information, for example the time stamp of the basic data, the origin of the basic data, the identification of the control unit 20, of the processing stage 30 or of another technical unit, features of the functional unit 12, 14, features of the sensor system 18, 18′ or further features with respect to the current working process of the functional unit 12, 14. The process data D_p1 may be generated in the processing stage 30, whereas the process data D_p2 may be generated in the control unit 20. The process data D_p1 and D_p2 are assigned to the respective basic data and are transferred as transfer data TD to the corresponding storage unit S1 or S2.

All of the transfer data TD, that is to say basic data S_sen, D_aus and process data D_p1, D_p2, are stored in the ledger 40 in an unalterable and encrypted manner. For the encryption of the transfer data TD, the processing stage 30 has a digital key kr1 and the control unit 20 has a digital key kr2. The encryption of the transfer data TD is indicated by the addition in brackets (kr1) or (kr2).

The processing stage 30 may contain an integrated interface for transmitting transfer data TD to the storage unit S1. In contrast, the storage unit 20 initially transmits encrypted data S_sen(kr2) and D_p2(kr2) to a separate data interface 42. This data interface 42 makes it possible to access a telecommunications connection (for example mobile radio) in order to connect the control unit 20 to the ledger 40 using data technology. In a parallel manner, the control unit 20 transmits the signals S_sen to the data processing apparatus 26 as unencrypted input data D_ein.

The distributed ledger 40 forms a type of data network with a limited number of authorized participants or technical modules for data transactions and/or access to data transactions already recorded in the ledger 40. In the present example, the two modules, the control unit 20 and the processing stage 30, may each be authorized for data transactions. The technical module 44 may only have authorization for read access to the data content of the storage units S1, S2. For their authorization within the data network or the ledger 40, the modules 20, 30, 44 may each have an appropriate digital certificate.

The module 44 is, in particular, assigned to an authorized institution that has the task of checking the documentation for emitted amounts of substances Em which is contained in the ledger 40. In this case, a comparison with the predetermined limit value W_gr can also be carried out in the module 44. As a result, a neutral entity can reliably check whether the predetermined limit value W_gr is complied with.

The module 44 uses a data network 46 (for example Internet) to access the ledger 40 and the recorded data content of the storage units S1, S2.

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A method for analyzing an amount of substance emitted as a result of the operation of a functional unit of a utility vehicle, the method comprising:
generating signals from a signal source independently of the amount of substance;
transmitting the signals to a data processing apparatus as input data for determining the emitted amount of substance;
processing the input data in the data processing apparatus to form output data which represent the emitted amount of substance; and
transferring the output data as transfer data to a storage unit of a digital distributed ledger.

2. The method of claim 1, further comprising:
transmitting the signals generated independently of the amount of substance as input data to a data processing apparatus which contains at least one neural network as a trained model for processing the input data; and
generating the output data in the data processing apparatus using the at least one neural network.

3. The method of claim 1, further comprising:
transferring the signals generated independently of the amount of substance as transfer data to at least one of the storage unit and a second storage unit of the digital distributed ledger.

4. The method of claim 1, further comprising:
generating process data;
assigning the process data to the signals generated independently of the amount of substance or to the output data; and
transferring the process data as transfer data to the storage unit of the digital distributed ledger.

5. The method of claim 1, further comprising storing the transfer data in an unalterable manner.

6. The method of claim 1, further comprising storing the transfer data in encrypted form.

7. The method of claim 6, further comprising encrypting the transfer data in a processing stage connected downstream of the data processing apparatus before transferring the transfer data to the digital distributed ledger.

8. The method of claim 6, further comprising encrypting the transfer data in a control unit of the utility vehicle before transferring the transfer data to the digital distributed ledger.

9. The method of claim 7, further comprising transferring the encrypted transfer data to the digital distributed ledger with a data interface of the utility vehicle.

10. The method of claim 1, further comprising accessing data content or a copy of the data content of the storage unit of the digital distributed ledger on the basis of an access authorization.

11. The method of claim 10, further comprising effecting access to the data content or the copy of the data content of the storage unit of the digital distributed ledger using a data network.

12. The method of claim 1, further comprising utilizing blockchain technology to carry out at least one of the steps of processing the input data and transferring the output data.

13. The method of claim 1, wherein the substance of the emitted amount of substance comprises at least one of NOx, CO2, CO, CmHn, N, NH4, P, and K.

14. The method of claim 1, wherein the functional unit comprises at least one of an internal combustion engine, an exhaust gas aftertreatment system, and a filling or application device for liquid manure.

15. The method of claim 1, wherein the signals generated independently of the amount of substance represent at least one of an exhaust gas temperature, a torque of an internal combustion engine, a speed of an internal combustion engine, and a variable influencing a liquid manure composition.

16. The method of claim 1, further comprising transmitting the input data to the data processing apparatus and transferring the transfer data to the storage unit of the digital distributed ledger on the basis of a comparison between the signals from the signal source and at least one predefined reference value.

17. The method of claim 16, wherein the predefined reference value as a calibration value represents a calibration state of the functional unit, and the signal from the signal source represents an actual state of the functional unit.

18. The method of claim 16, further comprising transmitting the input data to the data processing apparatus if a value of the signal from the signal source is greater than the predefined reference value.

19. The method of claim 16, further comprising transferring the transfer data to the storage unit of the digital distributed ledger if a value of the signal from the signal source is greater than the predefined reference value.

20. The method of claim 1, further comprising checking that the emitted amount of substance complies with a predetermined limit value.
